(19) United States
(12) Patent Application Publication
(10) Pub. No.: US 2014/0198032 A1
(43) Pub. Date: Jul. 17, 2014

(54) METHOD AND APPARATUS FOR DISPLAYING SCREEN WITH EYE TRACKING IN PORTABLE TERMINAL

(71) Applicant: Samsung Electronics Co., Ltd., Suwon-si (KR)

(72) Inventors: Yonggil HAN, Gumi-si (KR); Yeunwook LIM, Suseong-gu (KR); Gyucheol CHOI, Gumi-si (KR); Minho KIM, Gumi-si (KR); Kyeongwook MIN, Gumi-si (KR); Chulhyung YANG, Gumi-si (KR)

(73) Assignee: Samsung Electronics Co., Ltd., Suwon-si (KR)

(21) Appl. No.: 14/143,618

(22) Filed: Dec. 30, 2013

(30) Foreign Application Priority Data
Jan. 11, 2013 (KR) 10-2013-0003458

(51) Int. Cl. G06F 3/01

(52) U.S. Cl. CPC G06F 3/013
USPC 345/156

(57) ABSTRACT

A method and an apparatus for displaying a screen using an eye tracking in a portable terminal are provided. The method includes displaying a message on the display unit, photographing a user's eyeball through the camera unit when the message is displayed to determine a position of the user's eyeball, determining whether the message is read by comparing eye tracking information gathered by the photographing of the user's eyeball with a message position of a time point of displaying the message, and distinguishing an unread message from a read message based on the determining

### CROSS-REFERENCE TO RELATED APPLICATION(S)

This application claims the benefit under 35 U.S.C. §119(a) of a Korean patent application filed on Jan. 11, 2013 in the Korean Intellectual Property Office and assigned Serial No. 10-2013-0003458, the entire disclosure of which is hereby incorporated by reference.

### TECHNICAL FIELD

The present disclosure relates to a method and an apparatus for displaying a screen in a portable terminal. More particularly, the present disclosure relates to a method and an apparatus for displaying a screen using eye tracking in a portable terminal

### BACKGROUND

Recently, smart phones have essentially become a necessity for most people. For example, chatting through various chatting programs using the smart phone occurs frequently. However, when chatting in a room in which multiple people have entered, a problem may occur in which chatting content is missed because a user's reading speed cannot keep up with a scroll speed of a screen.

Meanwhile, in the case of an e-book, its bookmark function displays the last scrolled page when a reader does not read for a moment, or turns on or off the e-book so that a reader may conveniently read again. However, in general, the reader turns over the corresponding page, and turns off the e-book, or converts to a sleep mode after reading the content thereof When the user reads the book again, there is a problem in that the reader may unnecessarily read the content again, which may amount to almost one page, because the entire last scrolled page is shown.

Similarly, when searching a corresponding text such as an interne document or a cartoon article, there is a problem in that the reader should re-read the corresponding text from the beginning since it is displayed from the beginning, or the corresponding page must be searched depending on the reader's personal memory.

Accordingly, a need exists for an improved apparatus and method for displaying a screen based on eye tracking capable of remembering the last position read by the user and displaying from the remembered position by using eye tracking in a portable terminal.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and an apparatus for displaying a screen using eye tracking that is capable of remembering the last position read by a user and displaying from the remembered position in a portable terminal

Another aspect of the present disclosure is to provide a method and an apparatus for displaying a screen by using eye tracking to recognize whether a user of a reception terminal has read a message by using an eye tracking function so that a user of a transmission terminal may know whether the message has been read.

Another aspect of the present disclosure is to provide a method and an apparatus for displaying a screen by using eye tracking which may eliminate an inconvenience for a user reading a text in which the user must unnecessarily re-read the text by lifting up to display the last read point, when the user reads a text, stores the reading point of corresponding text, and tries to read the text again.

In accordance with an aspect of the present disclosure, a method of displaying a screen by using eye tracking in a portable terminal including a display unit and a camera unit is provided. The method includes displaying a message on the display unit, photographing a user's eyeball through the camera unit when the message is displayed to determine a position of the user's eyeball, determining whether the message is read by comparing eye tracking information gathered by the photographing of the user's eyeball with a message position of a time point of displaying the message, and distinguishing an unread message from a read message based on the determining

In accordance with another aspect of the present disclosure, a method of displaying a screen by using an eye tracking in a portable terminal including a display unit and a camera unit is provided. The method includes displaying a text on the display unit, eye tracking by determining and storing position information of a user's eyeball corresponding to the text through the camera unit, determining whether the portable terminal enters a sleep mode, and displaying a text position which the eye last tracked on an upper part of the display unit when a display request for the text occurs in the sleep mode.

In accordance with another aspect of the present disclosure, an apparatus for controlling a screen by using an eye tracking is provided. The apparatus includes a display unit configured to display a message on the screen, a camera unit configured to collect information photographed a user's eyeball in the eye tracking, and a controller configured to determine a position of the user's eyeball using the information collected through the camera unit, to determine a position of a corresponding message, and to compare the positions to display an unread message on an upper part of the display unit by determining the message as the unread message when the positions are not substantially identical.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram schematically showing a configuration of an apparatus for controlling a screen by using eye tracking according to an embodiment of the present disclosure;

FIG. 2 is a schematic diagram of a system which may verify a reception of a message between portable terminals according to an embodiment of the present disclosure;

FIGS. 3A and 3B are flowcharts showing a procedure for controlling a screen by using eye tracking according to an embodiment of the present disclosure;

FIG. 4 is a flowchart explaining a procedure of transmitting a chatting message and verifying a reception of a transmitting message by using eye tracking according to an embodiment of the present disclosure;

FIGS. 5A and 5B are diagrams illustrating controlling of a screen by using eye tracking according to an embodiment of the present disclosure;

FIGS. 6A, 6B, 6C and 6D are diagrams illustrating controlling of a screen by using eye tracking according to an embodiment of the present disclosure; and

FIG. 7 is a flowchart of controlling a screen by using eye tracking according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

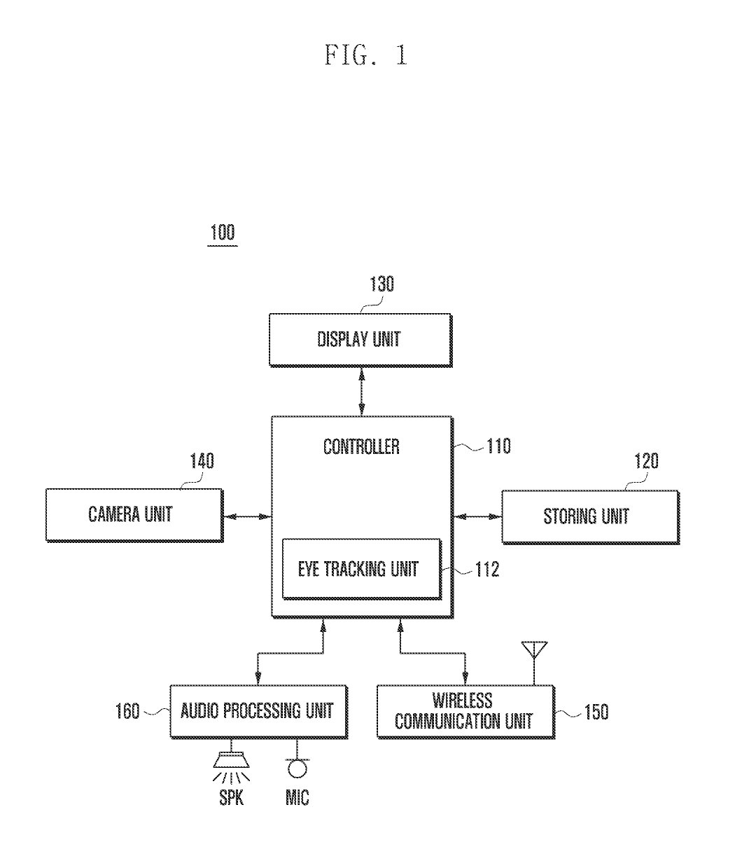

FIG. 1 is a block diagram schematically showing a configuration of an apparatus for controlling a screen by using eye tracking according to an embodiment of the present disclosure.

Referring to FIG. 1, a portable terminal 100 may include a controller 110, a storing unit 120, a display unit 130, a camera unit 140, a wireless communication unit 150, and an audio processing unit 160. The controller 110 may include an eye tracking unit 112.

The display unit 130 displays various menus of the portable terminal 100 as well as information input by a user, or information to provide to the user. For example, the display unit 130 may display various screens according to use of the portable terminal 100, such as a standby screen, a message writing screen, a call screen, an interne screen, a chatting screen, a text screen, and the like. For example, when a message is received at the time of chatting, the display unit 130 displays the received message. Such display unit 130 may be formed as a Liquid Crystal Display (LCD), an Organic Light Emitted Diode (OLED), an Active Matrix Organic Light Emitted Diode (AMOLED), and the like. When the display unit 130 is provided as a touch screen type, the display unit 130 may be operated as an input unit (not shown).

The camera unit 140 may photograph an image (e.g., a still image or a video). For example, the camera unit 140 is activated when an eyeball recognition mode is activated. In addition, the camera unit 140 may photograph an image of a user's face, and may transmit the collected information to the controller 110. To this end, the camera unit 140 may be selectively mounted at a position where a user's face can be photographed when the user faces the front of the display unit 130. Since the camera unit 140 is well known to people having ordinary skill in the art, a description thereof is omitted.

The audio processing unit 160 transmits an audio signal to a speaker (SPK), or may transmit an audio signal input by a microphone (MIC) to the controller 110. In other words, the audio processing unit 160 transmits an analog voice signal input by the microphone to the controller 110 by converting the analog voice signal to a digital voice signal, or outputs through the speaker by converting a digital voice signal to an analog voice signal. For example, the audio processing unit 160 may output a key input sound previously stored in the storing unit 120, a sound effect according to a function execution, a music file (e.g., an MP3 file) a playback sound, and the like. For example, the audio processing unit 160 may more clearly notify of whether eye tracking is started or terminated, or of whether a party receiving a message has read or otherwise verified the message by eye tracking by outputting a bit sound, a melody, a preset music file, a preset voice, or the like.

The wireless communication unit 150 establishes a communication channel for a voice call, a video call, or a data transmission such as transmission of a video or a message under the control of the controller 110. In other words, the wireless communication unit 150 establishes a voice call channel, a data communication channel, or a video call channel between the mobile communication systems. To this end, the wireless communication unit 150 may include a radio frequency transmission unit which performs up conversion and amplification of the frequency of the transmitting signal, and a radio frequency reception unit which performs low noise amplification and down conversion of the frequency of a receiving signal. The wireless communication unit 150 may also transmit an ACKnowledge (ACK) request message to request verification of whether a message is read as determined by eye tracking when transmitting the message. In response to the ACK request message, the wireless communication unit 150 may receive a response message, such as an ACK message notifying that the reception terminal 200 has read the message as determined by eye tracking.

The storing unit 120 may store a program necessary for operating a function of the portable terminal 100 as well as user data. Such a storing unit 120 may include a program area and a data area. The program area may store a program for controlling an overall operation of the portable terminal 100, an Operation System (OS) used for booting the portable terminal 100, an application program necessary for executing multimedia content or other options of the portable terminal, for example, an application program necessary for a camera function, a sound playback function, an image or video playback function, and the like. For example, the program area may store a program which determines, by eye tracking, a position of the user's eyeball by using information collected through the camera unit 140 at the time of displaying the message, and determines whether the position is substantially identical with a position of the time point of displaying the message to determine that it is read when the two positions are substantially identical, and to determine that it is not read when the two positions are not substantially identical. The storing unit 120 may include a program which re-displays a message that is determined as unread at a certain point. Here, the certain point may correspond to a time point of an immediate display, or may correspond to a point of time when eye tracking is re-started. In addition, the storing unit 120 may include a program which verifies whether the user is authenticated to output a message that is not eye tracked when the user is authenticated and to lock the display unit 130 when the user is not authenticated. In addition, the storing unit may store a program which notifies the terminal 100 transmitting the message of whether the terminal 200 receiving the message verifies receipt of a corresponding message by eye tracking when transmitting a chatting message.

The data area is an area where data generated according to use of the portable terminal is stored, and may store a phone book, an audio data and the corresponding contents, or the information corresponding to the user data. For example, the data area may store information of a position in which the user looks (i.e., reads) during eye tracking. In addition, the data area stores a time and a position of eye tracking when the message is received. Meanwhile, in case of the message, the data area divides and stores an eye tracked message and non-eye tracked message, and stores the last eye tracked position in case of the text. In addition, the data area may store the user's image for use of face information, if permitted.

The controller 110 may control an operation of the portable terminal 100 and a signal flow between internal blocks of the portable terminal 100. In an embodiment, the controller 110 may include the eye tracking unit 112 which is internally configured, when using the eye tracking function.

In more detail, the controller 110 verifies whether the eye tracking function is activated (i.e., ON) when outputting a message or a text, activates the camera unit 140 when the eye tracking function is activated, and may receive a user's face image which is photographed or captured through the camera unit 140. At this time, the eye tracking unit 112 recognizes an eyeball from the user's face image, and may generate eye tracking information by determining the position of the user's eyeball during the display and reading of the message or the text through eye tracking. For example, in the case of a message, such as a chatting message, the controller 110 determines the position of the user's eyeball by eye tracking from the time point of displaying the received message to compare with the position of the message at the time point of displaying, and determines that it is read when the positions are substantially identical, or determines that it is unread when the positions are not substantially identical.

The controller 110 may trace to perform eye tracking by a line unit in case of an internet, a Social Networking Service (SNS), and an e-book, and may store the last read point of the corresponding text. Alternatively, the controller 110 may store the position of the corresponding text by tracking the point of reading the corresponding text periodically when designating a time interval. For example, assuming that 20 lines of the text are displayed on one page, and read from the top, and when the camera unit 140 determines that the user's pupil is moved four times from a left end point to a right end point of the display and enters into a sleep mode, or terminates the corresponding program, the controller 110 determines that the user is ready to read the 5th line. After that, when the user exits from the sleep mode, or otherwise starts to read the text again, the controller 110 may place and display the 5th line of the corresponding page on the top of the display.

Meanwhile, when the user's face image is not photographed or captured through the camera unit 140, or an unauthorized user attempts to access the portable terminal 100, the controller 110 may lock the display unit 130.

Although not illustrated in FIG. 1, the portable terminal 100 may further selectively include elements to provide additional functions such as a broadcasting reception mode for a broadcasting reception, a digital music playback module such as an MP3 module, and a proximity' sensor module for a proximity sensing. Since the variation of such elements is very diverse according to the trend of digital convergence, it is not possible to describe all such elements here. However, the portable terminal 100 according to the present disclosure may further include the elements that have equivalent levels to the elements described above.

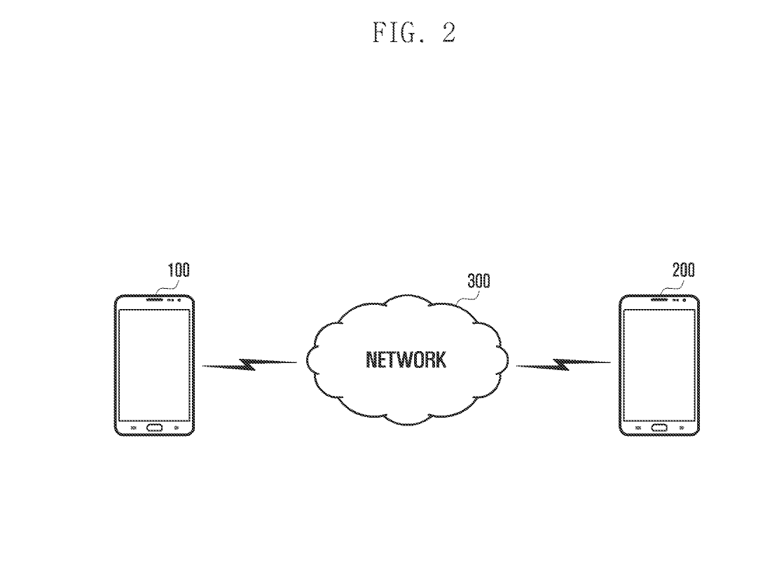

FIG. 2 is a schematic diagram of a system which may verify a reception of a message between portable terminals according to an embodiment of the present disclosure.

Referring to FIG. 2, the system may include a transmission terminal 100, a reception terminal 200, and a network 300.

FIG. 2 is a system which includes at least two portable terminals 100 and 200, and the network 300. The network 300 serves to relay a message transmitted and received between the portable terminals 100 and 200.

Such a network 300 may include a base station which forms a communication channel with the portable terminals 100 and 200, a base station controller which controls the base station, an exchanger which controls the base station controller and switches a call, and a billing unit which determines charges for each of portable terminal 100 and 200. Further, the network may include a local area communication network such as a WiFi, and a Bluetooth.

The transmission terminal 100 may transmit an ACK request message along with a text message to the reception terminal 200 through the network 300. When verifying that the text message has been read by using eye tracking after receiving the text message and the ACK request message, the reception terminal 200 generates a receipt confirmation ACK message corresponding to the ACK request message, and transmits the receipt confirmation ACK message to the transmission terminal 100 through the network. When the transmission terminal 100 receives the receipt confirmation ACK message, the user of the transmission terminal 100 may know that the user of the reception terminal 200 has verified the corresponding message through eye tracking. For convenience, only two portable terminals 100, 200 are illustrated in the drawing. However, in a case of a group chatting, a plurality of portable terminals may be connected to the network 300.

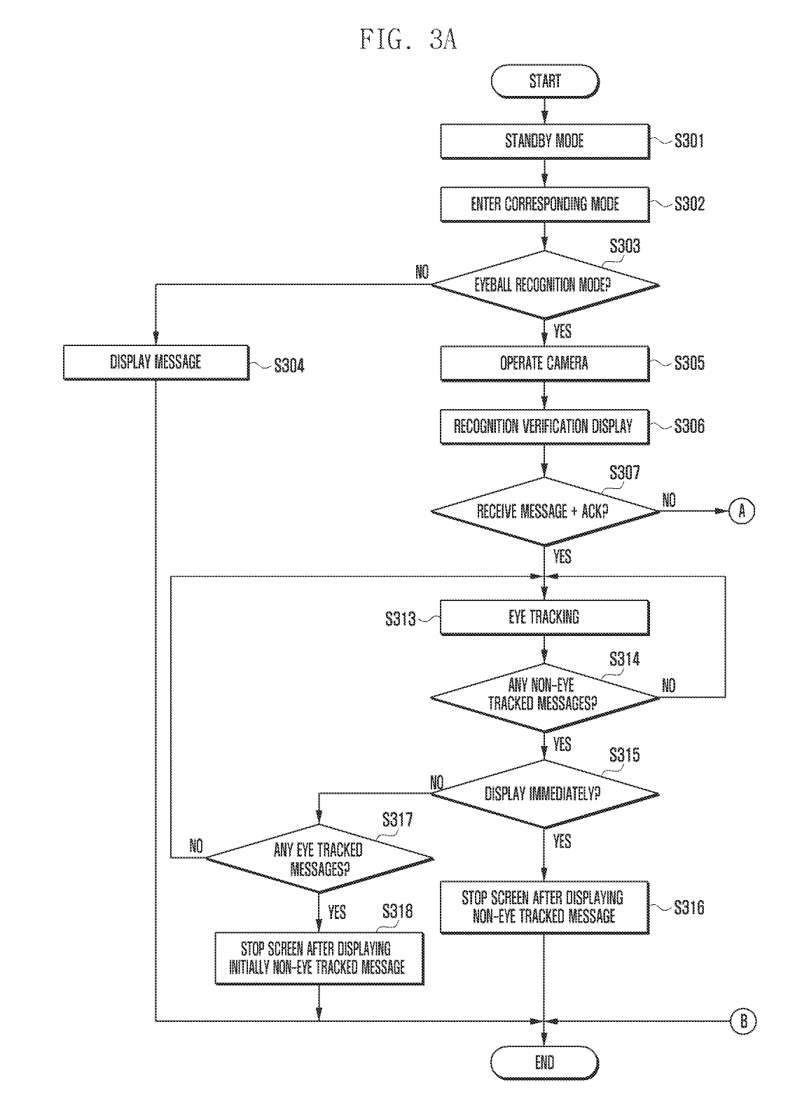

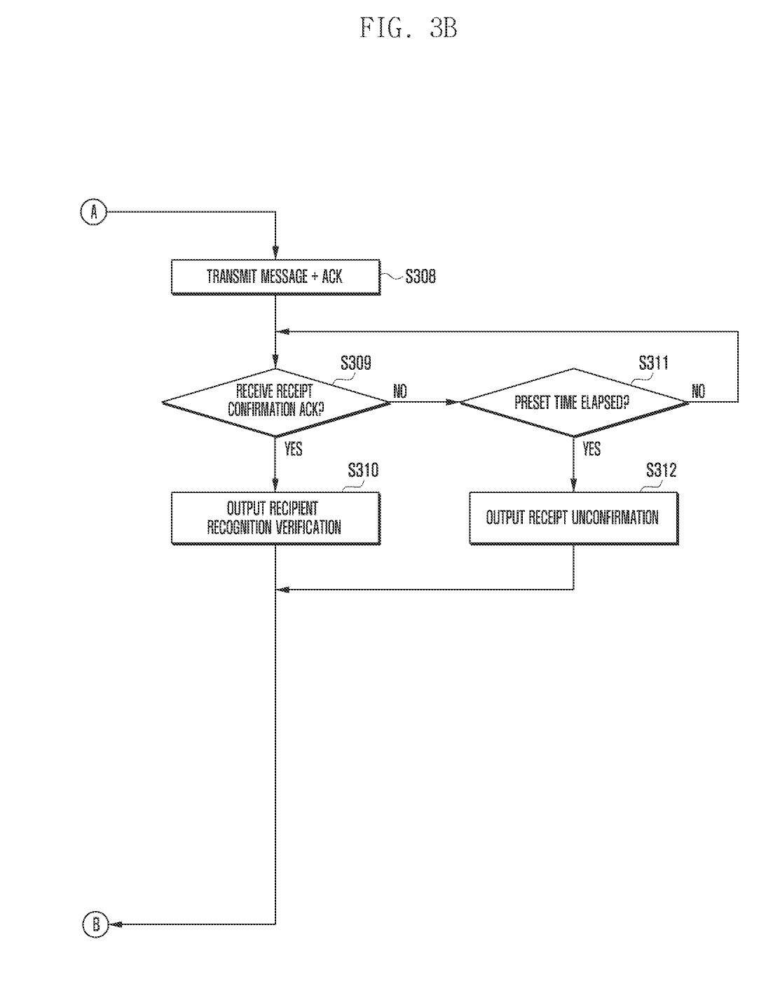

FIGS. 3A and 3B are flowcharts showing a procedure for controlling a screen by using eye tracking according to an embodiment of the present disclosure.

Referring to FIGS. 3A and 3B, the controller 110 displays a standby mode screen when the portable terminal is turned on at operation S301.

The controller 110 enters corresponding mode in response to the user's selection to process an event at operation S302. The corresponding mode refers to a mode which may execute a chatting message (e.g., a chatting application such as chat-on, kakaotalk, mypeople, and the like), a Multimedia Messaging Service (MMS) message, or a Short Messaging Service (SMS) message. For example, in the case of chat-on, it may be an execution of the chat-on application.

The controller 110 determines whether it is set in an eyeball recognition mode at operation S303. When it is determined not to be set in the eyeball recognition mode at operation S303, the controller 110 displays a corresponding message as a general message display scheme at operation S304. When it is determined to be set in the eyeball recognition mode at operation S303, the controller 110 operates the camera unit 140 at operation S305, and outputs a recognition verification display notifying that the user's eyeball is recognized at operation S306. At this time, the recognition verification display may be implemented by at least one of outputting a pop-up message, an icon, a bit sound, a melody, a preset music, a preset voice, or the like. For example, the pop-up message may be output to be minimally recognized by the user so that it may not interrupt the message reception and the eye tracking.

The controller 110 determines whether the message and the ACK request message are received at operation S307. If it is determined at operation S307 that the message and the ACK request message are not received, the controller 110 transmits the text message and the ACK request message to the reception terminal 200 through the network 300 at operation S308.

At operation S308, the reception terminal 200 receives the text message and the ACK request message. At this time, when the reception terminal 200 verifies the text message by using eye tracking, the receipt confirmation ACK message corresponding to the ACK request message is generated, and the reception terminal 200 transmits the receipt confirmation ACK message to the transmission terminal 100 through the network 300. The controller 110 of the transmission terminal 100 determines whether the receipt confirmation ACK message is received from the reception terminal 200 at operation S309. The controller 110 outputs a recipient's recognition verification by using at least one of a pop-up message, an icon, a bit sound, a melody, a preset music, a preset voice, or the like at operation S310, when the receipt confirmation ACK message is received after the determining at operation S309. Here, the recipient's recognition verification is an event notifying the transmission terminal 100 that the reception terminal 200 has read or otherwise verified the message by eye tracking. For example, when the pop-up message corresponding to the recipient's recognition verification is output to the transmission terminal 100, it may be known that the user of the reception terminal 200 has verified the corresponding message through eye tracking.

When it is determined at operation S309 that the receipt confirmation ACK message is not received, it is determined if the message receipt confirmation ACK message is received after a preset time has elapsed at operation S311. If it is determined at operation S311 that the message receipt confirmation ACK message is not received after a preset time, the controller 110 outputs a receipt un-confirmation by using at least one of a pop-up message, an icon, a bit sound, a melody, a preset music, a preset voice, or the like at operation S312. The receipt un-confirmation is an event notifying the user of the transmission terminal 100 that the message is not read or otherwise verified by eye tracking in the reception terminal 200. For example, when the pop-up message corresponding to the receipt un-confirmation is output to the transmission terminal 100, it may be easily known that the reception terminal 200 user did not read or otherwise verify the corresponding message through eye tracking.

The controller 110 performs eye tracking which determines or traces the position of the user's eyeball by using the information collected through the camera unit 140 at operation S313. In the case of the chatting message, the SMS, or the MMS, the controller 110 receives the message and generates eye tracking information by tracing or determining the position of the user's eyeball at the time point of displaying the message. Further, when the message is long, a line position of a specific message that the user read may be determined to be utilized as the eye tracking information. In another embodiment, a specific page which includes the messages read by the user may be traced and utilized as the eye tracking information.

The controller 110 determines whether the user read the specific message by determining the eye tracking information of operation S313, at operation S314. In particular, the controller 110 determines that the message is read when the eye tracked position at the point of time when the message is displayed is substantially identical with the position where the message is displayed, and determines that the message is not read when the positions are not substantially identical.

In addition, when the user's message is a long-message, the controller 110 may determine whether a specific line or message is read or not read by determining the line position of the message that the user read. Further, for a specific page including the messages that the user read, the controller 110 may determine that the message of a specific page is all read, and a specific page has the unread message. At this time, the receipt confirmation ACK message is generated for the read message to transmit to the portable terminal which sent a corresponding message, and stands-by for the unread message. The controller 110 determines whether to immediately display the message that is not read at operation S315, when there exists a message that is not read by the user by eye tracking at operation S314. When it is set to display the unread message immediately at operation S315, if the message determined to be unread is generated, the controller 110 displays the initially unread message on an upper part of the display unit 130 and stops the screen at operation S316. The message is received and displayed even after the screen is stopped. In addition, even the stopped screen may be scrolled by the user's selection.

When the message which is not read by eye tracking is not displayed immediately at operation S315, the controller 110 determines whether there is a message read by eye tracking after operation S314, at operation S317.

When it is determined that the message read by eye tracking is generated at operation S317, the controller 110 displays the message which is not eye tracked initially on the upper part of the display unit 130 and stops the screen at operation S318. Similarly, the message is received and displayed even after the screen is stopped. In addition, even the stopped screen may be scrolled by the user's selection. For example, in the case of a chatting program, by displaying the first unread message on the upper part of the application screen, it can be easily known that messages are not read from the corresponding message, and another unread message shown on the same screen is displayed to be distinguished from the read message. For example, text of read messages may be displayed differently than text of un-read messages or may be expressed differently though the various types of colors, sharpness, fonts of the letter, or through a combination of any of these.

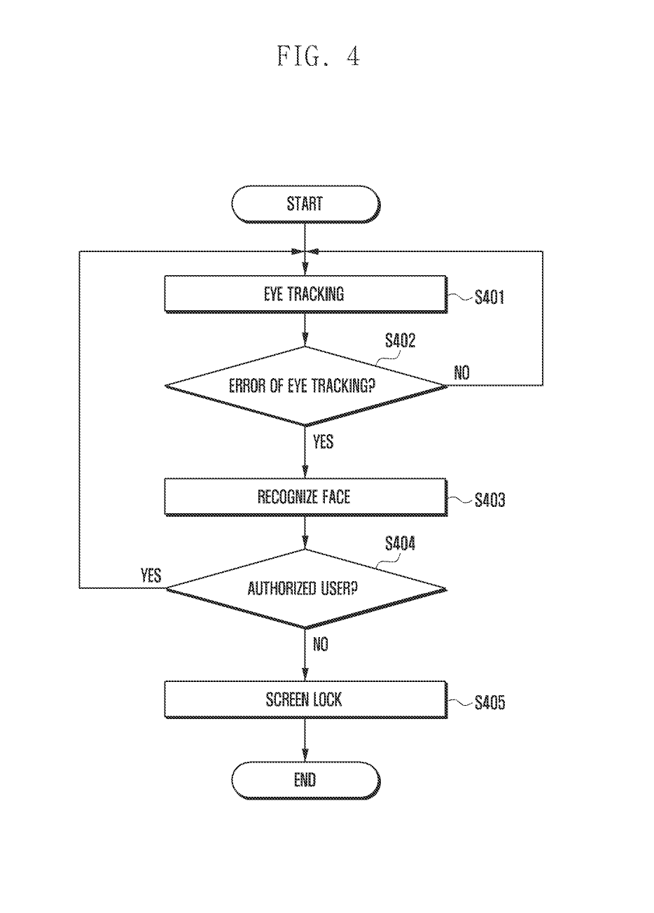

FIG. 4 is a flowchart explaining a procedure of transmitting a chatting message and verifying a reception of a transmitting message by using eye tracking according to an embodiment of the present disclosure. In FIG. 4, it is assumed that operations S313 to S318 of FIG. 3A are called eye tracking.

Referring to FIG. 4, during eye tracking at operation S401, the controller 110 determines whether a problem (i.e., an error) is generated in the eye tracking at operation S402. The problem generated at the time of eye tracking may occur when the user moves far away or disappears from a view of the camera unit 140, or due to other causes. The controller 110 returns to operation S401 when there is no problem in eye tracking at operation S402. When it is determined that the problem is generated during eye tracking at operation S402, the controller 110 photographs a face through the camera unit 140, and stores the photographed face information in the storing unit 120 at operation S403.

When it is determined that the user is authorized by comparing the face information stored in the storing unit 120 and preset authorized user information at operation S404, the controller 110 returns to operation S401 to perform eye tracking. At this time, as described above, the preset user information may be a plurality of authorized user image information, particularly, the face information. The controller 110 locks the screen at operation S405 when it is determined that the user is not authorized at operation 313.

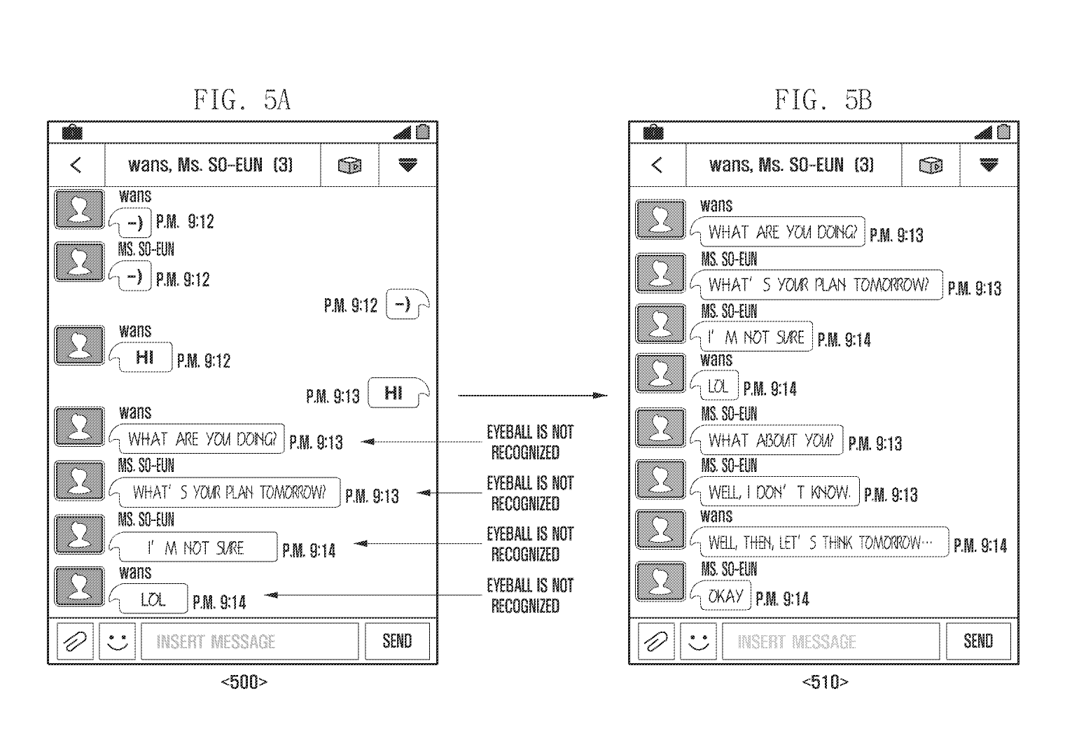

FIGS. 5A and 5B are diagrams illustrating controlling of a screen by using eye tracking according to an embodiment of the present disclosure.

Referring to FIG. 5A, reference numeral <500> shows that three people are chatting on a chatting window and the user of the transmission terminal 100 is chatting with two other users. In <500>, the messages “What are you doing”, “What's your plan tomorrow?”, “I am not sure”, “LOL (Laughing out loud)” are the messages recognized not to be read by eye tracking by the determining at operation S314 in FIG. 3A as described above, and displayed in a manner that is distinguished from the read message. For example, the unread texts may be displayed differently though use of various types of colors, sharpness, fonts of the letter, or through a combination of such types. The reference numeral <510> of FIG. 5B indicates a User Interface (UI) state where a screen is stopped after displaying the initially unread message “What are you doing” on the upper part when the message which is determined to be unread by eye tracking at operation S315 and operation S316.

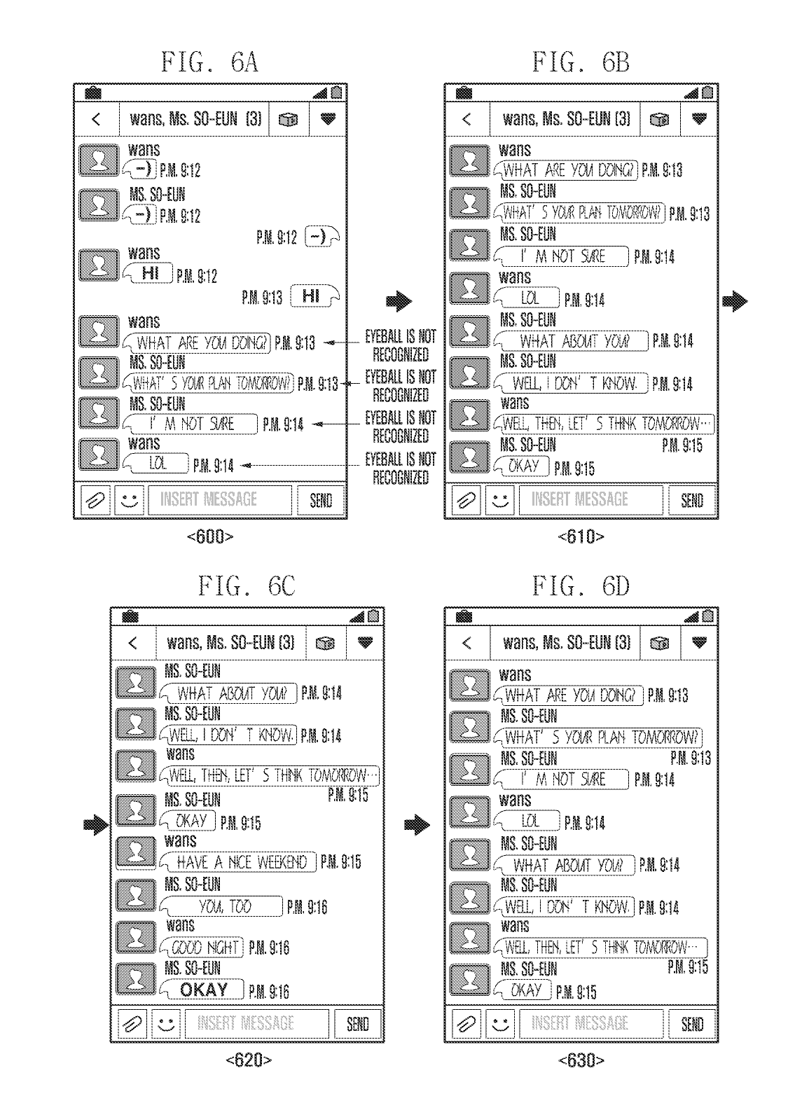

FIGS. 6A, 6B, 6C and 6D are diagrams illustrating controlling of a screen by using eye tracking according to an embodiment of the present disclosure.

Referring to FIGS. 6A to 6D, reference numeral <600> of FIG. 6A indicates the state of executing a chatting similar to reference numeral <500> of FIG. 5A, and “what are you doing”, “what's your plan tomorrow?”, “I am not sure”, “LOL” are the messages recognized as not yet read by eye tracking based on the determining at operation 5314. Reference numeral <610> of FIG. 6B indicates the state of executing a chatting and the chatting message is continuously being input. In FIG. 6C, the chatting state shown by reference numeral <620> is more progressed than the chatting state shown by reference numeral <610>, and indicates that the “okay” message is recognized by eye tracking in the state in which the chatting message is continuously being input. Since the message read by eye tracking at operations S317 and S318 of FIG. 3A is generated in <620>, the reference numeral <630> of FIG. 6D indicates the state in which the message initially unread by eye tracking is displayed on the upper part and the screen is stopped.

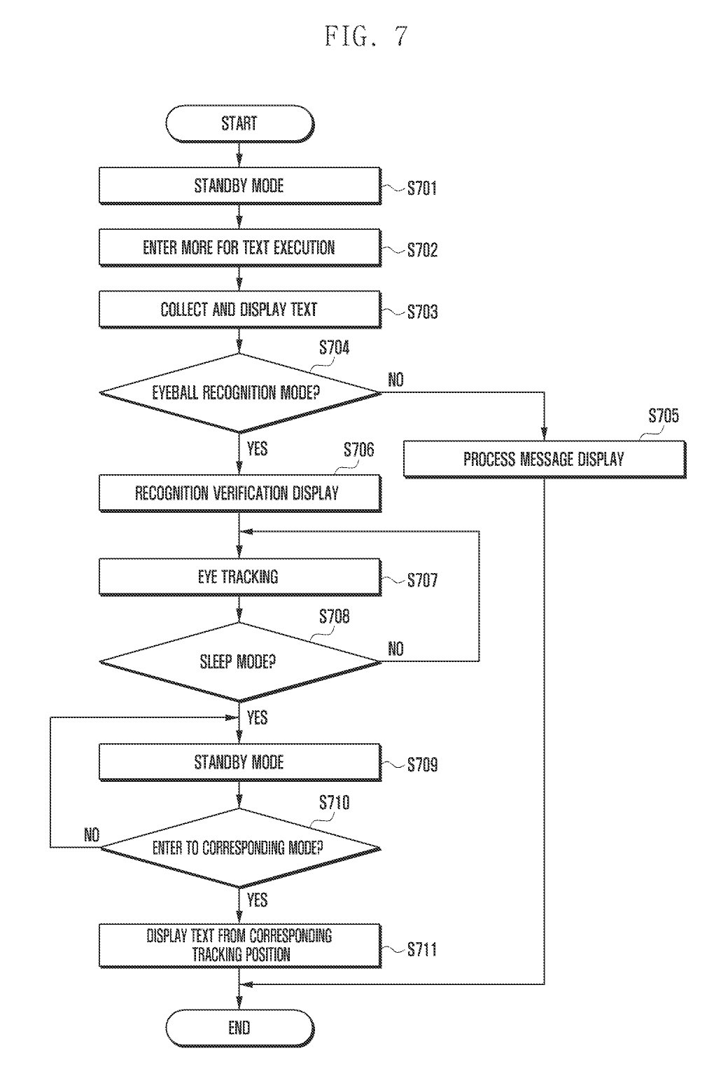

FIG. 7 is a flowchart of controlling a screen by using eye tracking according to an embodiment of the present disclosure.

Referring to FIG. 7, when a user turns on the portable terminal, the controller 110 displays the standby mode screen at operation S701 in FIG. 7.

The controller 110 enters a mode corresponding to text execution at operation S702. The corresponding mode refers to a mode of displaying text by executing an application. For example, the mode includes executing and displaying a text including a UI such as an e-book or an internet site (e.g., blog, café, news, and an SNS).

The controller 110 collects the text through a network such as an internet, a local communication, or a portable storing device, or displays the text already collected in a local communication on the display unit 130 at operation S703. The controller 110 determines whether it is set in an eyeball recognition mode at operation S704. When it is determined that it is not set in the eyeball recognition mode at operation S704, the controller 110 displays the corresponding text by the general text display scheme at operation S705. When it is determined that it is set in the eyeball recognition mode at operation S704, the controller 110 outputs the recognition verification display notifying that the user's eyeball is recognized at operation S706. At this time, the recognition verification display may be an output of at least one of a pop-up message, an icon, a bit sound, a melody, a preset music, a preset voice, or the like.

The controller 110 stores the eye tracking information by tracing or determining the position of the text that the user's eyeball follows by using the image photographed by the camera unit 140 at operation S707. When the eye tracking information is set based on a line unit, the line information of the last tracked corresponding text may be stored, and when a standard is set based on a preset time interval, the position of the text corresponding to the time which tracked last may be stored, and a specific page including the messages read by the user may be stored.

The controller 110 determines whether to enter into the sleep mode, or an event corresponding to the sleep mode is generated at operation S708. The event corresponding to the sleep mode may be an internet accessing block, an E-book termination, an SNS log out, a portable terminal off, and the like. When it is not the sleep mode, the controller 110 returns to operation S707 of performing eye tracking. In case of the sleep mode, the controller 110 determines whether to enter into the standby mode state at operation S709, and determines whether to enter into the corresponding mode at operation S710. Here, the corresponding mode refers to a mode of executing and displaying the text described at operation S702.

The controller 110 displays the text from the position corresponding to the tracking information stored last at the time point of eye tracking of operation S707 at operation S711.

As described above, a method and an apparatus for displaying a screen using eye tracking in a portable terminal according to an embodiment of the present disclosure remembers a last position that a user read and displays from the remembered position at the time of using a text function or chatting in a portable terminal, such that the user's convenience can be enhanced.

In addition, the present disclosure make it possible to recognize whether a reception terminal user has read the message by using an eye tracking function, and to let the transmission terminal user know whether the message has been read when receiving the recognized information such that the user's convenience can be enhanced.

In addition, when the user reads a text, it stores the read point of the corresponding text, so when the user tries to read thereof again, the present disclosure may eliminate an inconvenience for a text-reading user to unnecessarily read the already read point again by lifting up to display the last read point, when the user reads a text, stores the reading point of corresponding text, and tries to read the text again.

It will be appreciated that various embodiments of the present disclosure according to the claims and description in the specification can be realized in the form of hardware, software or a combination of hardware and software.

Any such software may be stored in a non-transitory computer readable storage medium. The non-transitory computer readable storage medium stores one or more programs (software modules), the one or more programs comprising instructions, which when executed by one or more processors in an electronic device, cause the electronic device to perform a method of the present disclosure.

Any such software may be stored in the form of volatile or non-volatile storage such as, for example, a storage device like a Read Only Memory (ROM), whether erasable or rewritable or not, or in the form of memory such as, for example, Random Access Memory (RAM), memory chips, device or integrated circuits or on an optically or magnetically readable medium such as, for example, a Compact Disk (CD), Digital Versatile Disc (DVD), magnetic disk or magnetic tape or the like. It will be appreciated that the storage devices and storage media are various embodiments of non-transitory machine-readable storage that are suitable for storing a program or programs comprising instructions that, when executed, implement various embodiments of the present disclosure. Accordingly, various embodiments provide a program comprising code for implementing apparatus or a method as claimed in any one of the claims of this specification and a non-transitory machine-readable storage storing such a program.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for displaying a screen by using eye tracking in a portable terminal including a display unit and a camera unit, the method comprising:
displaying a message on the display unit;
photographing a user's eyeball through the camera unit when the message is displayed to determine a position of the user's eyeball;
determining whether the message is read by comparing eye tracking information gathered by the photographing of the user's eyeball with a message position of a time point of displaying the message; and
distinguishing an unread message from a read message based on the determining.

2. The method of claim 1, wherein the distinguishing of the unread message from the read message comprises displaying letters of the unread message differently from letters of the read message.

3. The method of claim 1, wherein the determining of whether the message is read comprises determining a line of a specific message that the user read.

4. The method of claim 1, wherein the determining of whether the message is read comprises determining a specific page including the messages read by the user.

5. The method of claim 1, wherein the distinguishing comprises displaying the unread message on an upper part of the display unit when it is determined that the message is unread.

6. The method of claim 1, wherein the distinguishing further comprises stopping and displaying the screen of the display unit.

7. The method of claim 1, further comprising:
when it is determined that the message is unread, determining whether a message read by the eye tracking exists; and
displaying an initially unread message on an upper part of the display unit.

8. The method of claim 7, wherein the displaying of the initially unread message comprises stopping the screen of the display unit.

9. The method of claim 1, further comprising:
determining whether the portable terminal is set in an eyeball recognition mode after the displaying of the message; and
displaying a recognition verification display notifying that a user's eyeball is recognized, when the portable terminal is set in the eyeball recognition mode.

10. The method of claim 9, wherein the recognition verification display outputs at least one of a pop-up message, an icon, a bit sound, a melody, a preset music, or a preset voice.

11. The method of claim 1, further comprising:
determining whether an eye tracking error is generated during the photographing of the user's eyeball;
recognizing a face and storing face information;
comparing the stored face information with authorized user information; and
locking the display unit when it is determined that the face information is not substantially identical with the authorized user information.

12. The method of claim 1, further comprising:
transmitting a transmission message to a reception terminal through a mobile communication network; and
outputting at least one of a pop-up message, an icon, a bit sound, a melody, a preset music, or a preset voice that verifies receipt of the message by the reception terminal

13. The method of claim 1, further comprising:
transmitting a transmission message to a reception terminal through a mobile communication network; and
outputting at least one of a pop-up message, an icon, a bit sound, a melody, a preset music, or a preset voice that notifies that the reception terminal did not receive the message.

14. A method for displaying a screen by using eye tracking in a portable terminal including a display unit and a camera unit, the method comprising:
displaying a text on the display unit;
eye tracking by determining and storing position information of a user's eyeball corresponding to the text through the camera unit;
determining whether the portable terminal enters a sleep mode; and
displaying a text position which the eye last tracked on an upper part of the display unit when a display request for the text occurs in the sleep mode.

15. The method of claim 14, wherein the position information corresponds one of a line unit or a time interval.

16. The method of claim 14, further comprising:
determining whether the portable terminal is set in an eyeball recognition mode after the displaying of the text; and
displaying a recognition verification notifying that a user's eyeball is recognized through at least one of a pop-up message, an icon, a bit sound, a melody, a preset music, or a preset voice when the portable terminal is set in the eyeball recognition mode.

17. An apparatus for controlling a screen by using an eye tracking, the apparatus comprising:
a display unit configured to display a message on the screen;
a camera unit configured to collect information of a user's eyeball; and
a controller configured to determine a position of the user's eyeball using the information collected through the camera unit, to determine a position of a corresponding message, and to compare the positions to display an unread message on an upper part of the display unit by determining the message as the unread message when the positions are not substantially identical.

18. The apparatus of claim 17, further comprising a storing unit configured to store information of the user's face.

19. The apparatus of claim 18, wherein the controller is further configured to compare the stored information of the user's face with information collected by the camera unit and to compare the stored information with the collected information to determine if access is permitted.

20. A non-transitory computer-readable storage medium storing instructions that, when executed, cause at least one processor to perform the method of claim 1.
